(19) United States
(12) Patent Application Publication
(10) Pub. No.: US 2017/0312732 A1
(43) Pub. Date: Nov. 2, 2017

(54) Copper Nanoparticle Based Formulations for Sterilization and Purification

(71) Applicant: Kunal Upadya, Lady Lake, FL (US)

(72) Inventor: Kunal Upadya, Lady Lake, FL (US)

(21) Appl. No.: 15/475,426

(22) Filed: Mar. 31, 2017

Related U.S. Application Data
(60) Provisional application No. 62/328,058, filed on Apr. 27, 2016.

(51) Int. Cl. B01J 20/06; B01D 61/14; B01J 20/24; C02F 1/44; C02F 1/28; B01J 20/30; B01D 15/00; B01J 20/28; B01J 20/32; C02F 101/10

(52) U.S. Cl. CPC B01J 20/06; B01J 20/28047; B01D 61/145; B01J 20/24; C02F 1/444; C02F 1/281; B01J 20/3208; B01J 20/3085; B01D 15/00; B01J 20/28045; B01J 20/28026; B01J 20/28007; B01D 2325/12; C02F 2101/105; C02F 2303/04

(57) ABSTRACT

Copper based nanoparticle composite compositions, methods, and systems for purification and sterilization of contaminated water are provided.

### CROSS-REFERENCE TO RELATED APPLICATION

This application claims priority of U.S. Provisional Application Ser. No. 62/328,058, entitled “Copper-Cellulose Nanocomposites for Antimicrobial Applications”, filed Apr. 27, 2016, the disclosure of which is incorporated herein by reference in its entirety.

### FIELD OF THE INVENTION

The invention relates to copper nanoparticle based formulations, compositions, and devices containing such formulations or compositions. Novel devices can be including copper based nanoparticles can be used to sterilize hazardous microbes, while other devices can be used to absorb hazardous inorganic compounds such as phosphates or arsenic. Some devices can be useful for antimicrobial activity and purification of water sources.

### BACKGROUND

According to water.org, over 750 million people worldwide do not have access to clean, safe water. Disease, caused by unclean water and contaminated surfaces, kills many people every year.

One objective of the instant invention is to efficiently and safely filter or disinfect water from sources or surfaces that may be contaminated. The systems disclosed herein for disinfecting or filtering contaminated water sources or other fluids are anticipated to be less expensive than other known systems and affordable for millions worldwide.

Apart from use in developing countries, copper nanocomposites can be used in filtration systems in developed countries. Chlorine is commonly used to disinfect water in cities, and while effective at killing microbes, it can leave undesirable tastes and smells, and can form harmful disinfection by-products.

Further, some protozoa are resistant to chlorine. The instant invention is advantageous in that, resistant organisms such as giardia and other protozoa can be efficiently eliminated, thus avoiding disease and potential loss of life.

Sponges used for cleaning can be a medium for harboring bacteria, and often contain large amounts of potentially harmful bacteria. Using copper nanocomposite sponge material to kill bacteria and to prevent the growth of bacteria is desirable in a wide range of commercial and household applications.

Some known compositions have been proven effective at disinfection, however, leakage of copper nanoparticles into the water or other medium to be disinfected is known to be a significant problem.

United States Pub. No. 20150336804 (“Dankovich”) discloses an environmentally benign method for the direct in situ preparation of copper nanoparticles (CuNPs) in (e.g. cellulose) paper by reducing sorbed copper ions with ascorbic acid. Copper nanoparticles were formed in less than 10 minutes and were well distributed on the paper fiber surfaces. Paper sheets were characterized by x-ray diffraction, scanning electron microscopy, energy dispersive x-ray spectroscopy, and atomic absorption spectroscopy. Antibacterial activity of the CuNP sheets was assessed for by passing Escherichia coli bacteria suspensions through the papers. The effluent was analyzed for viable bacteria and copper release. The CuNP papers with higher copper content showed a high bacteria reduction of log 8.8 for E. coli. The paper sheets containing copper nanoparticles were effective in inactivating the test bacteria as they passed through the paper. The copper levels released in the effluent water were below the recommended limit for copper in drinking water (1 ppm).

United States Pub. No. 20080147019 (“Song”) discloses material compositions, including metallic nanoparticles of silver, silver alloys, or copper, having antimicrobial properties. The metallic nanoparticles are embedded or encapsulated in a matrix formed of chitosan or chitosan derivative-based compounds.

United States Pub. No. 20140319044 (“Giannelis”) discloses nanoparticle functionalized membranes, where the surface of the membranes is nanoparticle functionalized. The nanoparticles closest to the membrane surface are covalently bonded to the membrane surface. The membranes are forward osmosis, reverse osmosis, or ultrafiltration membranes and can be used in devices or water purification methods.

United States Pub. No. 20110129536 (“Donati”) provides nanocomposite systems made of metallic nanoparticles stabilized with branched cationic polysaccharides, in particular alditolic or aldonic mono- and oligo-saccharidic derivatives of chitosan. The peculiar chemical and physical-chemical features of these polysaccharides allow formation of metallic nanoparticles homogeneously dispersed in the polysaccharidic matrix and an effective stabilization thereof. The properties associated with the nanometric dimensions and the presence of biological signals on polymeric chains may be exploited in applications with antimicrobial activities and of molecular biosensors.

United States Patent No. 8,563,020 (“Uhlmann”), is directed to a composition having antimicrobial activity comprising particles comprising at least one inorganic copper salt; and at least one functionalizing agent in contact with the particles, the functionalizing agent stabilizing the particle in a carrier such that an anti-microbially effective number of ions are released into the environment of a microbe. The average size of the particles ranges from about 1000 nm to about 4 nm. Preferred copper salts include copper iodide, copper bromide and copper chloride. Preferred functionalizing agents include amino acids, thiols, hydrophilic polymers (cellulose) emulsions of hydrophobic polymers and surfactants.

U.S. Patent No. 8,057,682 (“Hoag”) relates to methods of making and using and compositions of metal nanoparticles formed by green chemistry synthetic techniques. For example, metal nanoparticles formed with solutions of plant extracts and use of these metal nanoparticles in removing contaminants from soil and groundwater and other contaminated sites.

U.S. Patent No. 7,381,686 (“Lin”), discloses composite for inhibiting algae growth comprising a polypore base carrier and a nano-metal mixture coated on the carrier, wherein the mixture comprising a nano-metal particle and a substance for fixing the particle on the carrier.

U.S. Patent No. 6,998,058 (“Koslow”) is directed to a microbiological interception enhanced filter medium, preferably having an adsorbent pre-filter located upstream from the filter medium. The pre-filter is adapted to remove natural organic matter in an influent prior to the influent contacting the microbiological interception enhanced filter medium, thereby preventing loss of charge on the filter medium. The microbiological interception enhanced filter medium is most preferably comprised of fibrillated cellulose fibers, in particular, lyocell fibers. At least a portion of the surface of the at least some of the fibers have formed thereon a microbiological interception enhancing agent comprising a cationic metal complex. A filter medium of the present invention provides greater than about 4 log viral interception and greater than about 6 log bacterial interception.

Antibacterial Activity of Nanocomposites of Copper and Cellulose, Ricardo J. B. Pinto et al., BioMed Research International, Volume 2013 (2013), Article ID 280512, 6 pages http://dx.doi.org/10.1155/2013/280512 (“Pinto”) discloses the use of copper nanostructures combined with biopolymers such as cellulose. Nanocomposites comprising copper nanofillers in cellulose matrices have been prepared by in situ and ex situ methods. Two cellulose matrices (vegetable and bacterial) were investigated together with morphological distinct copper particulates (nanoparticles and nanowires). A study on the antibacterial activity of these nanocomposites was carried out for Staphylococcus aureus and Klebsiella pneumoniae, as pathogen microorganisms. The results showed that the chemical nature and morphology of the nanofillers have great effect on the antibacterial activity, with an increase in the antibacterial activity with increasing copper content in the composites. The cellulosic matrices also show an effect on the antibacterial efficiency of the nanocomposites, with vegetal cellulose fibers acting as the most effective substrate. A wide range of antibacterial materials with potential use in diverse applications such as packaging or paper coatings are suggested.

The problem of rising phosphate levels in water sources is prevalent worldwide, particularly in the northern United States. Removing phosphate from water can be difficult and expensive. The primary method used for phosphate removal is chemical precipitation. However, chemical precipitation has significant drawbacks. For example, chemical precipitation is expensive because molecules of phosphate must be reacted with a substrate. Lime, one of the most common substrates used for precipitating phosphates, increases the pH of water and results in creation of hazardous sludge. Furthermore, this method is largely ineffective in environments such as lakes or streams because the amount of substrate necessary to a have an efficacious effect of phosphate content is too large. Also, because there is no usable end product, there is very little incentive for private industry to reduce levels of phosphates present in water. The compounds and methods disclosed herein can be used to adsorb or desorb phosphates or arsenic compounds, thus presenting new and useful tools for purification of contaminated water sources.

Therefore, the present invention is directed to improved disinfection or adsorption devices and methods, and in particular, devices such as copper nanocomposite infused sponges useful for filtering and disinfecting bacteria containing water. Further, such sponges can be used to disinfect surfaces while inhibiting bacterial growth within the sponge material itself. In some embodiments of the invention, copper oxide nanoparticles compositions can be used to efferently adsorb phosphate or arsenic compounds in water purification systems.

### BRIEF DESCRIPTION OF THE DRAWINGS

FIG. 1 depicts particle size distribution data for copper nanoparticles.

FIG. 2 depicts particle size distribution data copper nanoparticle cellulose composites.

FIG. 3 depicts growth of bacteria versus time for various test configurations.

FIG. 4 depicts the number of bacterial colonies counted for various test configurations.

FIG. 5 depicts the concentration of nanoparticles vs. concentration of phosphate after adsorption by CuO nanoparticles.

FIG. 6 depicts concentration of nanoparticles vs. concentration of phosphate after adsorption by loaded alginate gel beads.

### SUMMARY OF THE INVENTION

In one non-limiting embodiment, a composition includes an alginate gel and copper oxide particles. The copper oxide particles can be impregnated in the alginate gel.

In an embodiment of this aspect, the alginate gel can be calcium alginate.

In some embodiments, the alginate gel can be in the form of alginate beads.

In certain embodiments, the copper oxide particles can be nanoparticles.

In other embodiments, the alginate gel can be in the form of calcium alginate beads and the copper oxide particles can be nanoparticles.

In another aspect, a method for water purification includes the steps of adding copper nanoparticle impregnated alginate gel to a water source containing phosphates, adsorbing the phosphates by the copper oxide nanoparticle impregnated alginate gel beads, thereby purifying the water source.

In some embodiments of this aspect, the copper nanoparticles can be copper oxide nanoparticles.

In other embodiments, the alginate gel can be calcium alginate beads.

In certain embodiments, the copper nanoparticles can be copper oxide nanoparticles and the alginate gel can be calcium alginate beads.

In another embodiment, the method further including the step of treating the copper oxide nanoparticle impregnated alginate gel beads with a base, thereby desorbing the adsorbed phosphates.

In another non-limiting aspect of the present invention a nanoparticle composite composition includes a plurality of copper nanoparticles and a cellulose polymer matrix. The nanoparticles can be impregnated in the matrix.

In one embodiment of this aspect, each of the plurality of copper nanoparticles can be in the range of between about 5 nm and about 100 nm.

In yet another embodiment, at least 25% of the plurality copper nanoparticles can be in the range of between about 5 nm and about 40 nm.

In some embodiments, the copper cellulose nanocomposite composition can be in the range of between about 2000 nm and about 5000 nm.

In certain embodiments, each of the plurality of copper nanoparticles cab be between about 5 nm and about 100 nm and the nanocomposite composition can be between about 2000 and about 5000 nm.

In another embodiment, at least 25% of the plurality of copper nanoparticles can be in the range of between about 5 nm and about 40 nm and about 100 nm, and the nanocomposite composition can be between about 2000 and about 5000 nm.

In another non-limiting aspect, an antimicrobial sponge includes a sponge material and a nanoparticle composite composition. The composition can include a plurality of copper nanoparticles and a cellulose polymer matrix. The nanoparticles can be impregnated in the matrix, and the composition can be impregnated in the sponge material.

In one embodiment, the sponge material can be a medical grade cellulose based sponge.

In certain embodiments, each of the plurality of copper nanoparticles can be between about 5 nm and about 100 nm and the nanocomposite composition can be between about 2000 and about 5000 nm.

In some embodiments, at least 25% of the plurality of copper nanoparticles cab be in the range of between about 5 nm and about 40 nm.

In one non-limiting embodiment of the instant invention nanoparticle composites includes nanoparticles and nanocomposites that include the nanoparticles thereon or therein.

In some embodiments, the nanoparticles can include copper nanoparticles.

In a particular embodiment, the copper nanoparticles can be in the range of between about 5 nm and about 100 nm.

In one embodiment, at least 25% of the copper nanoparticles can be in the range of between about 5 nm and about 40 nm.

In certain embodiments, the copper nanoparticles can form a polymer matrix nanocomposite.

In particular embodiments, the polymer matrix can include cellulose.

In some embodiments, the copper cellulose nanocomposite can be in the range of between about 2000 nm to 5000 nm.

In other embodiments, the nanocomposite can be in the range of between about 216 nm to 21,149 nm.

In a particular embodiment, the copper nanoparticles can be about 5 - 100 nm and the nanocomposite can be about 2000-5000 nm.

In one embodiment, at least 25% of the copper nanoparticles can be in the range of between about 5 nm and about 40 nm and the nanocomposite can be in the range of about 2000-5000 nm.

In some embodiments if the instant invention, copper cellulose nanocomposites or capped copper nanoparticles can be infused in or on a cellulose based sponge. While typical copper nanoparticles are too small to use in a sponge because they will wash out or leech out, the copper-cellulose nanocomposites can be absorbed or adsorbed by a sponge, and will be retained by the sponge with minimal leaching, and thus maximize the anti-microbial properties of the nanocomposite treated sponge.

In some embodiments, the nanocomposite treated sponge can be a used as a water filter or standalone disinfection device for surfaces.

In some embodiments, a copper cellulose nanocomposite filter can be used to disinfect water. The filter can include an ultrafiltration membrane.

In another embodiment, the filter can be used as a container as well as a filter, thereby allowing the filter to be used efficiently and affordably.

In one non-limiting embodiment of the present invention, a filtration system includes a filter media and a support structure. The system includes copper nanoparticle cellulose composites sized to kill microbes in water without leaching copper a bio-harmful quantity of nanoparticles into the water.

In some embodiments, nano particulate paint can be applied to a sponge or to a filter media, such as fiberglass or cellulose in order to trap the nanoparticles effectively for use in treating a contaminated substrate or a contaminated water source.

In one non-limiting embodiment, copper nanoparticles or copper cellulose nanocomposites can be printed directly onto a cellulose sponge.

In one aspect of this embodiment, the copper nanoparticles can be between about 5 nm and 100 nm and the nanocomposite can be between about 2000 nm and 5000 nm.

In certain aspects, a compound having antimicrobial activities can include a plurality of alginate gel beads and copper nanoparticles.

In some embodiments, the copper nanoparticles can include copper or copper oxide.

In certain embodiments, the compound can include an alginate gel containing copper or copper oxide nanoparticles and a cellulose matrix containing copper or copper oxide nanoparticles.

In some embodiments, the compound can include alginate gel beads containing copper oxide nanoparticles for purification and a cellulose matrix copper nanoparticle composite for sterilization.

In a particular embodiment, the alginate gel composite can include copper and copper oxide nanoparticles for use as an antimicrobial agent and an adsorbent of pollutants such as phosphates or arsenic and compounds thereof.

### DESCRIPTION

As used herein, gram-negative bacteria are a known class of bacteria that are characterized by thin cell walls compared to gram-positive bacteria. Many gram-negative bacteria are pathogenic, and can be harmful to animals, including humans.

As used herein, gram-positive bacteria are known bacteria that are usually characterized by thick cell walls. Most gram-positive bacteria are not pathogenic, and therefore are not harmful to humans.

As used herein, a capping agent is a monolayer of organic molecules that can be used to aid the stabilization of nanoparticles. Capping agents enclose the nanoparticles, and do not react with them. They will, however, make the nanoparticles advantageously larger, unlike surfactants, which will not.

Alginate, commercially available as alginic acid, sodium salt, commonly called sodium alginate, is a linear polysaccharide normally isolated from many strains of marine brown seaweed and algae, thus the name alginate. The copolymer consists of two uronic acids: D-mannuronic acid (M) and L-guluronic acid (G). Because it is the skeletal component of the algae it has the nice property of being strong and yet flexible.

As used herein, alginate beads can refer to any form of alginate polymer. Alginic acid can be either water soluble or insoluble depending on the type of the associated salt. The salts of sodium, other alkali metals, and ammonia are soluble, whereas the salts of polyvalent cations, e.g., calcium, are water insoluble, with the exception of magnesium. The alginate polymer itself is anionic (i.e., negatively charged) overall. Polyvalent cations bind to the polymer whenever there are two neighboring guluronic acid residues. Thus, polyvalent cations are responsible for the cross-linking of both different polymer molecules and different parts of the same polymer chain. The process of gelation, simply the exchange of calcium ions for sodium ions, is carried out under relatively mild conditions. Because the method is based on the availability of guluronic acid residues, which will not vary once given a batch of the alginate, the molecular permeability does not depend on the immobilization conditions. Rather, the pore size is controlled by the choice of the starting material.

Alginate is currently widely used in food, pharmaceutical, textile, and paper products. The properties of alginate utilized in these products are thickening, stabilizing, gel-forming, and film-forming. Alginate polymers isolated from different alginate sources vary in properties. Different algae, or for that matter different part of the same algae, yield alginate of different monomer composition and arrangement. There may be sections of homopolymeric blocks of only one type of monomer (-M-M-M-) (-G-G-G-), or there may be sections of alternating monomers (-M-G-M-G-M-). Different types of alginate are selected for each application on the basis of the molecular weight and the relative composition of mannuronic and guluronic acids. For example, the thickening function (viscosity property) depends mainly on the molecular weight of the polymer; whereas, gelation (affinity for cation) is closely related to the guluronic acid content. Thus, high guluronic acid content results in a stronger gel.

Copper nanoparticles can be synthesized via known methods. See, for example, Synthesis, characterization, and antimicrobial properties of copper nanoparticles. International Journal of Nanomedicine, 2013:8, pp. 4467-4479.

While copper is naturally found as a trace metal in the environment, too much of copper can be toxic. However, copper nanoparticles can also be toxic to bacteria. Copper ions are known to be toxic to bacteria. While copper nanoparticles are toxic at a concentration of about 195 parts per million, copper ions are toxic at a concentration of about 15 parts per billion.

Size, shape and surface of nanoparticles have a significant effect on the properties of nanoparticles. By altering the temperature of the initial reaction, the quantity of reactants, and capping agents, specific sizes of nanoparticles can be synthesized. The smaller the nanoparticles, the larger the total surface area, thus allowing for a greater oxidation and a greater toxicity to bacteria. For copper nanoparticles, it is believed that the optimal size for use in eliminating harmful bacteria is between about 5 nm and 100 nm.

As used herein, a nanocomposite is a matrix in which nanoparticles are trapped in order to improve certain properties of the material. Most nanocomposites can fall into the broad categories of ceramic-matrix, metal-matrix, or polymer-matrix nanocomposites, as defined by the type of material mainly used to make the matrix.

As defined herein, polymer-matrix nanocomposites consist of a polymer having nanoparticles dispersed on or in the polymer. Polymer nanocomposites can serve to amplify the properties of nanoparticles by allowing for the use of smaller nanoparticles, therefore increasing the surface-area to volume ratio. Polymer nanocomposites can also serve to strengthen the nanoparticles, and to make them more heat resistant as well as less susceptible to oxidation. Some known uses of polymer-matrix nanocomposites include tissue engineering, drug delivery, and immobilization of protein.

Cellulose, a preferred polymer, is an organic compound with the formula C₆H₁₀O₅. Cellulose has been used to make paper and cardboard. It is insoluble in water, and it is made up of beta-glucose monomers. As a polymeric fiber, it can act as efficiently as the polymer matrix in a nanocomposite. The cellulose fibers can link together forming a “cloud” of nanoparticles, thus entrapping them for use in disinfection while preventing leeching. For copper nanoparticle cellulose based composites, it is believed that the optimal size for use in eliminating harmful bacteria while maximizing retention is between about 2000 nm and 5000 nm.

As used herein, sponges are porous materials that can retain other materials, usually liquids. Synthetic sponges are commonly made from cellulose or other polymers. Sponges are often used for cleaning, but can also be used to soak up or retain other substances. One significant problem with sponges is that they can contain large amounts of bacteria, especially when kept wet between uses, for example, a kitchen or bathroom sponge which can spread disease when contaminated by bacteria.

Medical grade sponges can have smaller pores than commercial sponges, and can absorb large amounts of liquid quickly. For example, Kettenbach GmbH & Co. KG manufactures a cellulose sponge material under the tradename Sugi® sponge, which is effectively used in various medical fields such as ophthalmology, ENT-surgery, diagnostics, wound care, micro surgery, etc. Such sponge materials are desirable because they have an open pore structure allowing for a greater surface area, which creates an ideal environment for binding agents such as nanoparticle composites.

Antimicrobial copper-cellulose nanocomposites.

The instant copper nanoparticles and nanocomposites were manufactured and characterized using a Hitachi 7100 transmission electron microscope.

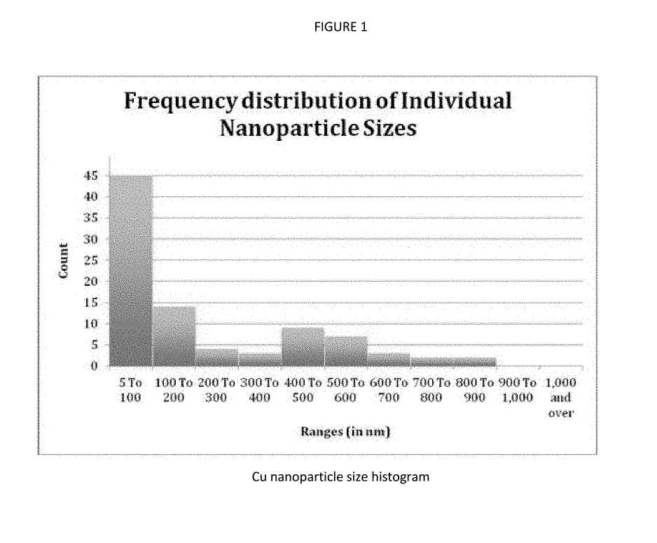

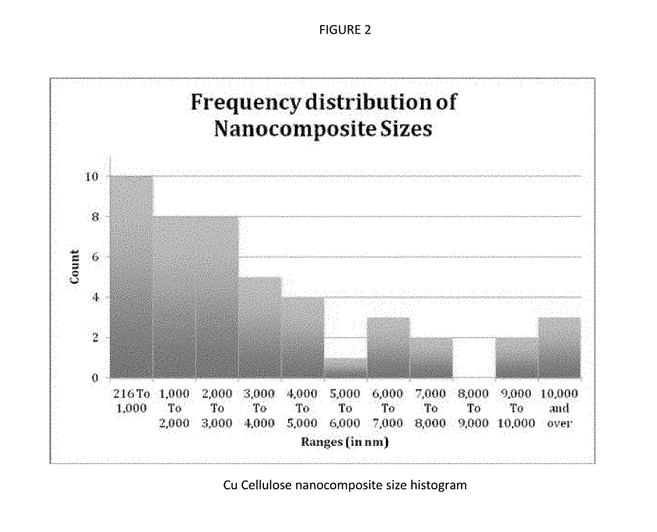

The copper nanoparticles were confirmed to have formed in clusters of nanocomposites, held together by cellulose fibers. The majority of the nanoparticles were sized between 5 and 100 nm, while about 34% of the nanoparticles were between 5 and 40 nm. However, the clusters of nanocomposites were sized much larger, ranging from about 216 nm to 21,149 nm. Nanocomposites were most commonly found in the range of about 2000 to 5000 nm as shown in FIGS. 1 and 2.

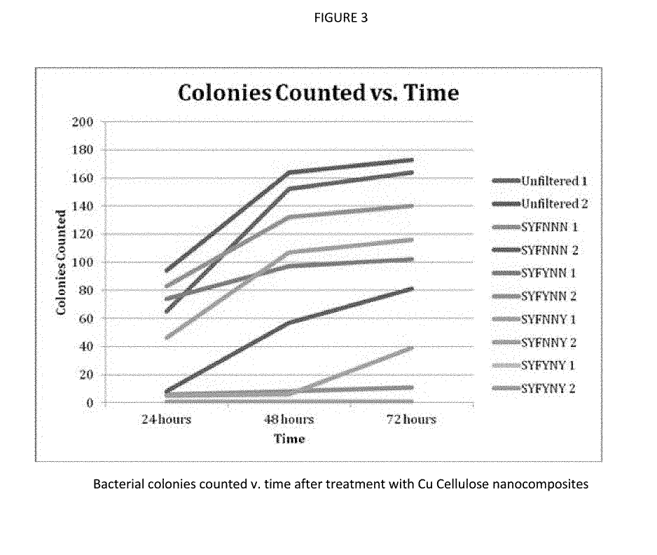

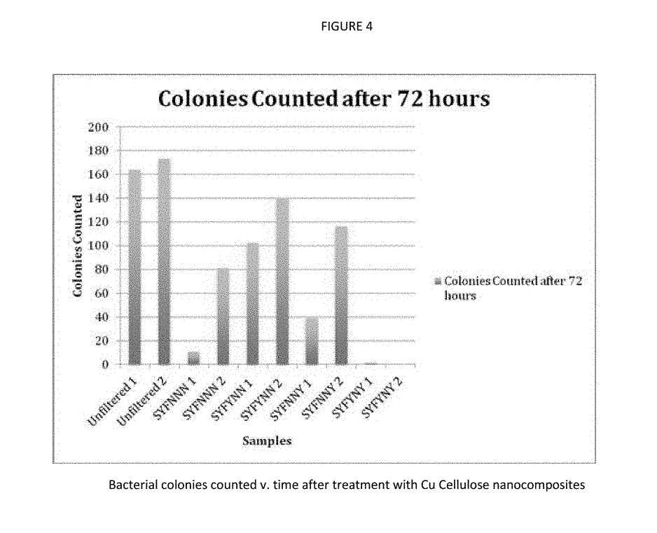

In the bacterial culturing test, each sample was streaked onto a chocolate agar plate. (SYFNNN 1 stands for sponge yes; filter no; nanoparticles no; first trial. This means that the sample was filtered using the cellulose sponge, but not the filter, and without nanoparticles.) The results are shown in Table 1 and depicted in FIGS. 3-4.

TABLE 1
Chocolate agar Culture Colony count

| | SYFYNN | SYFNNY | SYFNNY | SYFYNY | SYFYNY |
|---|---|---|---|---|---|
| Hours | 2 | 1 | 2 | 1 | 2 |
| 0 | 0 | 0 | 0 | 0 | 0 |
| 24 | 83 small | 5 small | 46 very | 1 tiny | 0, no |
| | colonies, | colonies | small | colony, | growth |
| | one small | | colonies | not in | |
| | lawn | | | quadrant | |
| | | | | one | |
| 48 | 132 small | 6 medium | 107 very | 1 tiny | 0, no |
| | colonies, | sized | small | colony, | growth |
| | two large | colonies | colonies | not is | |
| | lawns | | | quadrant | |
| | | | | one | |
| 72 | 140 small | 39 | 116 very | 1 small | 0 no |
| | colonies, | colonies, | small | colony, | growth |
| | 3 large | new ones | colonies | not in | |
| | lawns, | very | | quadrant | |
| | agar | small, | | one | |
| | turning | old ones | | | |
| | black | very | | | |
| | | large | | | |

The plates were checked at intervals of 24, 48, and 72 hours, after which the bacteria stopped growing and the death phase began. In the plate streaked with unfiltered water 1, there was heavy growth, with 65 colonies after 24 hours, 152 colonies after 48 hours, and 164 colonies after 72 hours. At 72 hours, there were also “lawns” of bacteria indicating areas so dense with bacteria that they are uncountable while the agar turned black and red due to depletion of the nutrients.

In the plate streaked with unfiltered water 2, there was also heavy growth, with 94 colonies after 24 hours, 164 colonies after 48 hours, and 173 colonies after hours. At 72 hours, there were 9 lawns, and the agar blackened.

In the plate streaked with water which had been filtered through a sponge only there were 6, 8, and 11 very large colonies after 24, 48, and 72 hours respectively. In the plate that had been streaked with SYFNNN 2, there were 8, 57, and 81 colonies respectively after 24, 48, and 72 hours. These colonies were small, but there were 7 lawns.

In the plate that had been streaked with SYFYNN 1, there were 74, 97, and 102 small colonies after 24, 48, and 72 hours. At 72 hours, there were 2 large lawns, and the agar was turning black. In the plate that had been streaked with SYFYNN 2, there were 83, 132, and 140 small colonies after 24, 48, and 72 hours. There were also three large lawns, and the agar was turning black. In the plate that had been streaked with SYFNNY 1, there were 5, 6, and 39 colonies after 24, 48, and 72 hours. In the plate that had been streaked with SYFNNY 2, there were 46, 107, and 116 small colonies after 24, 48, and 72 hours.

The last samples were the filtered samples. The plate that had been streaked with SYFYNY 1 had 1 colony from 24 hours onwards; however, this colony was not in quadrant 1. The plate that had been streaked with SYFYNY 2 had no growth whatsoever in it. This was an unexpected positive result.

Based on centrifuge results, both unfiltered water 1 and 2 were found to contain small amounts of particulate matter.

Thus, it has been demonstrated that a filtration system, such as an impregnated sponge, using novel copper cellulose nanocomposites successfully killed all of the bacteria in a sample of water without leaching copper nanoparticles. In particular, the combination of an ultrafiltration membrane, cellulose sponge, and a novel copper-cellulose nanocomposite efficiently killed bacteria from pond water samples.

The copper-cellulose nanocomposite that was disclosed herein has unique properties. Relatively small individual particle size, in order to maximize surface area, and relatively large nanocomposite size, in order to minimize the number of nanoparticles that can leach through a filter or sponge. The nanoparticles were largely between 5 and 100 nm, and the nanocomposites were largely between 2000 and 5000 nm. This morphology led to a nanoparticle filter or disinfection system that was much more effective for its size than conventional copper nanoparticle devices or known filters.

While both samples of unfiltered water had heavy growth all around the plate(s), the filtered water samples only had one colony on either plate. Furthermore, the one colony was not in quadrant 1, suggesting that it may have come from an outside contaminant.

Further, the water filtered using cellulose sponge and nanoparticles performed noticeably better than the unfiltered water, despite having a much higher flow rate and therefore less contact time.

The filter system of the instant invention kept undesirable nanoparticles and particulate matter out of the filtered water, as the centrifuge test and the microscope test demonstrated. In both tests, the unfiltered water had relatively large amounts of particulate matter, while filtered water had virtually no particulate matter or nanoparticles that had leeched from the composite.

Copper oxide—alginate gel nanocomposites for water purification.

Copper oxide nanoparticle impregnated alginate gel beads are were found to be useful in adsorbing and desorbing phosphates. For example, 0.68 grams of copper oxide nanoparticles were used in the form of 36.1 grams of loaded alginate gel beads (i.e. CuO gel composite) to absorb 100 mg of phosphate. The phosphate was releasable from the in the presence of high pH (e.g. NaOH solution).

This method of purification allows for reduction of the amount of phosphate in water, and for collection and use the adsorbed phosphate, instead of merely forming a hazardous and unusable sludge.

Furthermore, this method does not interfere with the pH of the treated water, and does not release a significant amount of copper into the water. For example, one sample of loaded alginate gel beads were allowed to sit in solution for over four months. Afterwards, the water had a copper concentration of about 1 mg/L, less than the EPA recommended amount of 1.3 mg/L. This data demonstrates that the copper does not dissolve out of the alginate gel bead composite, and is therefore safe as an adsorbent for phosphates.

Furthermore, after being placed in a NaOH solution, the beads released the phosphate into the surrounding solution. This property is quite important because it allows for the removal of phosphates from water, and the recovery of phosphates for use in fertilizers, synthetic detergents, or other uses. This method is not only effective at adsorbing phosphate, but is also effective for recovery and use of a hazardous pollutant.

Another potential use of these CuO nanoparticle based alginate gel composite beads is for adsorption of arsenic. Methods to adsorb phosphate can also work on arsenic. Methods to test for the presence of phosphate are also usually interfered with by high levels of arsenic.

This suggests that this method will also work to remove arsenic from water, which could be crucial to combatting high arsenic levels in areas such as West Bengal, where 35 million people are in areas with high levels of arsenic contamination. Normally, arsenic is removed by the usage of reverse osmosis membranes, however these are expensive and difficult to maintain. Furthermore, precipitation of arsenic is more difficult than phosphate due to solubility issues. This makes adsorption of arsenic by these alginate gel beads a promising method for removing arsenic from water.

### EXAMPLES

Nanoparticles were synthesized using a known method. In the first step, 10 mL of a 0.05 M solution of copper (II) sulfate was stirred and refluxed at 120° C., and 0.5 mL of ascorbic acid (0.05 M) was added. After waiting minutes 2 mL of sodium hydroxide (0.6 M) was added. Finally, 0.5 mL of hydrazine (0.05 M) was added to the solution, which turned reddish-black to signify the formation of copper nanoparticles.

A 100 mg/L solution of phosphate was created by adding sodium phosphate to distilled water. This was then serially diluted to get solutions of concentrations of 50, 12.5, 6.25, 3.125, 1.5625, 0.78125, 0.390625, 0.1953125, and 0.09765625 mg/L.

Ascorbic acid reagent was used as a colorimetric method of measuring the amount of phosphate in solution. The reagent forms molybdenum blue when in the presence of phosphate, and colors the water blue, which is detectable on a colorimeter or spectrophotometer at the 625-nm wavelength. 25 mL of 14% sulfuric acid, 2.5 mL of 4% potassium antimonyl tartrate, 7.5 mL of 4% ammonium molybdate solution, and 15 mL of 0.1M ascorbic acid were mixed together).

Copper oxide nanoparticle loaded alginate gel beads were fabricated. A 2% sodium alginate solution was made by stirring sodium alginate into water under slight heating. Approximately 20 mL of sodium alginate solution was mixed with 0.4 g CuO nanoparticles. This solution was then dripped into 40 mL of 1% calcium chloride solution, and was allowed to sit for ten minutes. When the beads had hardened, they were washed and transferred to a distilled water solution. This process unexpectedly produced alginate gel beads that were about half alginate and half CuO nanoparticles.

Nine 50 mL solutions of 100 mg/L phosphate produced. Then, the copper oxide nanoparticles were added in different amounts to solution from a 5.6 mL solution of nanoparticles containing 0.09 g of CuO nanoparticles. This solution was constantly stirred, while 5, 10, 20, 40 80, 160, 320, 1000, and 2000 μm was added respectively. This resulted in solutions with 0.08, 0.16, 0.32, 0.64, 1.28, 2.57, 5.14, 16.07, and 32.14 mg phosphate/50 mL.

Another 50-mL solution of phosphate was made at a concentration of 50 mg/L. 2000 μm of the copper nanoparticle solution was added to this solution to create an effective 4000 μm assay. This resulted in a solution with a CuO nanoparticle concentration of 64.28 mg/50mL.

Next, 6.2 g of sodium alginate beads was used to create ten more assays. Ten 50 mL solutions of 100 mg/L phosphate were produced. Then, 0.0040175, 0.008035, 0.01607, 0.03214, 0.06428, 0.12856, 0.25712, 0.8035, 1.607, and 3.214 g of sodium alginate beads was added to each of these solutions to create ten different assays. These assays were then allowed to sit for 24 hours, providing time for the nanoparticles to adsorb the phosphate.

Using the serial dilutions reference above, 5 mL of each of the phosphate standards was reacted with 0.8 mL of ascorbic acid reagent. The 100 mg/L sample was then run to check the absorbance spectrum to ensure that there was a peak at 625 nm. Each of the standards was then run in the spectrophotometer to determine the absorbance at 625 nm.

Beer's Law was applied to the serial dilution to determine the region on which Beer's law holds. Then, this curve was used to create a linear and power piecewise regression that could be used to find the concentration of phosphate at a given the absorbance.

Using a glass cuvette, the absorbance spectrum of the ascorbic acid reagent was measured. Then, 5 mL of each sample to be tested in the assays was placed in a glass test tube and reacted with 0.8 mL of ascorbic acid reagent and shaken vigorously. This was also done for two control samples, and one tap water sample. Each sample was run in the spectrophotometer to calculate the absorbance at 625 nm.

Using a standard copper water test kit, test the water for traces of copper in the water by adding 10 drops of reagent to 5 mL of solvent and comparing the color of the solution to the color card.

Nanoparticles were successfully synthesized. The solution began blue, turned green with the addition of sodium hydroxide, and turned reddish-black with the addition of hydrazine. Phosphate standards were successfully created, and a serial dilution was performed. The ascorbic acid reagent was successfully created, and it took on a yellow. Copper oxide nanoparticle loaded alginate gel beads were successfully created. The composition effectively trapped the copper oxide nanoparticles so that they did not leach through into the surrounding solution.

Then, the serial dilution was colorized and tested in the spectrophotometer, and a series of points was obtained. This could then be used in conjunction with Beer's Law to find a range for which absorbance and concentration are linearly correlated.

For the ascorbic acid reagent, it was found that Beer's Law held best in the region of 0-3.125 mg/L of phosphate. Concentration vs. absorbance between 0 and 3.125 mg/L graphed with a linear regression, showed the relationship to be linear. In this region, it was found that the linear relationship was strong, with a correlation coefficient of 0.9986.

However, it was also determined that in the region between 3.125 and 6.25 mg/L, the correlation between concentration and absorbance remained strong, for a polynomial function. Because this would be useful in extrapolating the data slightly outside of the normal range of Beer's law, a piecewise function was used for calculating concentration if given absorption.

If the absorbance was greater than 0.7, then the concentration was greater than 6.25. If the absorbance was greater than 0.5, but less than 0.7, then: 0.0118*(absorbance²)+0.1835*(absorbance)+0.0127)=(concentration). If the absorbance is less than 0.5, then: (absorbance)*0.1461+0.0256=(concentration).

Based on this methodology, calculations were performed on the amount of phosphate in the water and the amount of copper nanoparticles, in order to determine how much phosphate was adsorbed for each standard of copper oxide nanoparticles.

By using the equation: (100-observed phosphate concentration)/20/amount of CuO NP *1000 on the lowest concentration of nanoparticles that adsorbed almost all the phosphate, calculations where performed to determine that each (1) mg of copper oxide nanoparticles could, at its peak, adsorb up to 146.35 μg of phosphate. Based on this determination, 0.68 grams of copper nanoparticles would be able to adsorb 100 mg of phosphate from 1 liter. This implies approximately 36.1 grams of alginate composite gel beads. Having made these calculations, it was possible to test the effectiveness of the alginate gel beads as compared to the free nanoparticles.

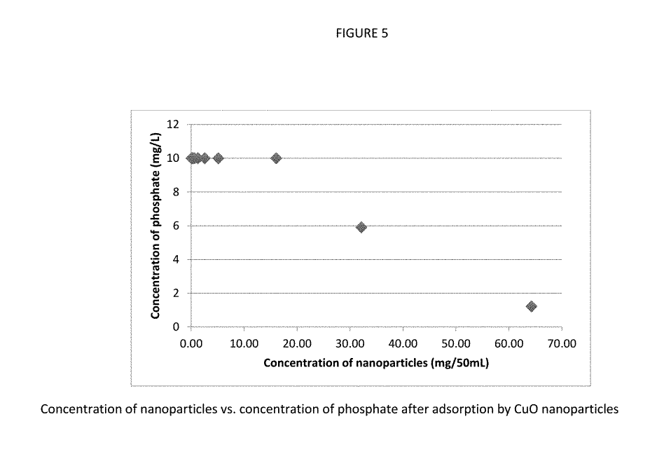

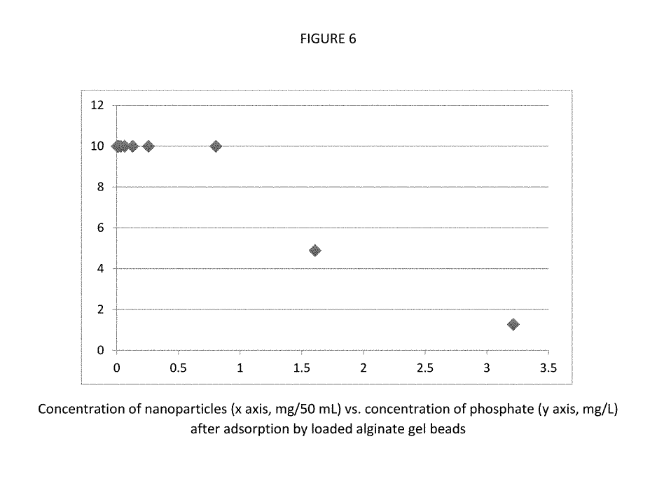

The alginate loaded gel beads adsorbed almost the same amount of phosphate as the free CuO nanoparticles. FIGS. 5-6 depict the concentration of nanoparticles vs. concentration of phosphate after adsorption by CuO nanoparticles and CuO nanoparticle loaded gel beads, respectively.

Each of the masses of alginate beads held about the same number of nanoparticles as the free nanoparticle counterpart, therefore the final phosphate concentrations between the loaded alginate beads and the free nanoparticles were comparable.

The amount of copper dissolved in the water was measured using a standard copper test kit. This was done in order to determine whether the loaded alginate gel beads would retain the nanoparticles in such that the water remained potable and safe. The two samples measured were the free nanoparticle solutions, which were expected to have very high levels of copper, and the loaded nanoparticle solution, which should have had low or no copper dissolved.

The copper test kit demonstrated that the concentration of copper in the water was well above the safe limit of 1.3 mg/L, and was higher than 4.0 mg/L. This water unsafe to drink.

In stark comparison, the copper test kit for loaded alginate beads showed that the concentration of copper in the water was about 1.0 mg/L, which is below the EPA recommended 1.3 mg/L for drinking water. It should be noted that this reading was taken after allowing the beads to sit in the same solution for four months, therefore giving the beads a longer time to release their nanoparticles. However, the surprisingly beads did not even release enough copper nanoparticles for the water to contain an unsafe level of copper. This test demonstrated that that the alginate Cu0 gel beads are stable, and do not release dangerous levels of copper.

When the nanoparticles were placed in a pH 14 NaOH solution, they released the phosphate back into solution. When the nanoparticles were placed back into a phosphate solution with a pH of 7, less than the zero-point charge of 9.5, the nanoparticles again adsorbed phosphate. This process demonstrated a reversible efficient method of adsorbing and recovering phosphates.

Thus, the use copper oxide nanoparticles to adsorb phosphate was clearly demonstrated. It was found that 1 mg of copper oxide nanoparticles was able to adsorb up to 146.35 μg of phosphate. In order to prevent the nanoparticles from leaching into the water, the nanoparticles were loaded into alginate beads, and were again tested to see if the loading decreased the efficiency of the nanoparticles, however the nanoparticles ended up adsorbing about the same amount of phosphate. This indicates that the alginate gel beads allow for full or near full contact, allowing efficient adsorption between the nanoparticles and the surrounding water.

Although the invention herein has been described with reference to particular embodiments, it is to be understood that these embodiments are merely illustrative embodiments and that other arrangements may be devised without departing from the spirit and scope of the present invention as defined by the disclosure herein.

What is claimed is:

1. A composition comprising:
an alginate gel; and
copper oxide particles, said copper oxide particles being impregnated in said alginate gel.

2. The composition of claim 1, wherein said alginate gel is calcium alginate.

3. The composition of claim 1, wherein said alginate gel is in the form of alginate beads.

4. The composition of claim 1, wherein said copper oxide particles are nanoparticles.

5. The composition of claim 1, wherein said alginate gel is in the form of calcium alginate beads and said copper oxide particles are nanoparticles.

6. A method for water purification comprising:
adding copper nanoparticle impregnated alginate gel to a water source containing phosphates;
adsorbing the phosphates by said copper oxide nanoparticle impregnated alginate gel beads, thereby purifying the water source.

7. The method of claim 6, wherein said copper nanoparticles are copper oxide nanoparticles.

8. The method of claim 6, wherein said alginate gel is calcium alginate beads.

9. The method of claim 6, wherein said copper nanoparticles are copper oxide nanoparticles and said alginate gel is calcium alginate beads.

10. The method of claim 6, further including the step of:
treating said copper oxide nanoparticle impregnated alginate gel beads with a base, thereby desorbing said adsorbed phosphates.

11. A nanoparticle composite composition comprising:
a plurality of copper nanoparticles;
a cellulose polymer matrix, wherein said nanoparticles are impregnated in said matrix.

12. The composition of claim 11, wherein each of said plurality of copper nanoparticles is in the range of between about 5 nm and about 100 nm.

13. The composition of claim 12, wherein at least 25% of said plurality copper nanoparticles are in the range of between about 5 nm and about 40 nm.

14. The composition of claim 11, wherein the copper cellulose nanocomposite composition is in the range of between about 2000 nm and about 5000 nm.

15. The composition of claim 11, wherein said each of said plurality of copper nanoparticles is between about 5 nm and about 100 nm and said nanocomposite composition is between about 2000 and about 5000 nm.

16. The composition of claim 15, wherein at least 25% of said plurality of copper nanoparticles is in the range of between about 5 nm and about 40 nm.

17. The composition of claim 11, further including a sponge material, wherein and said composition is impregnated in said sponge material.

18. The composition of claim 17, wherein said sponge material is a medical grade cellulose based sponge.

19. The composition of claim 17, wherein said each of said plurality of copper nanoparticles is between about 5 nm and about 100 nm and said nanocomposite composition is between about 2000 and about 5000 nm.

20. The composition of claim 17, wherein at least 25% of said plurality of copper nanoparticles is in the range of between about 5 nm and about 40 nm.
